(19) United States
(12) Patent Application Publication
(10) Pub. No.: US 2008/0200604 A1
(43) Pub. Date: Aug. 21, 2008

(54) Method For Coating Surfaces

(75) Inventors: Andreas Fechtenkotter, Ludwigshafen (DE); Bernd Duttra, Hassloch (DE); Michael Ehle, Ludwigshafen (DE); Martin Scholtissek, Wachenheim (DE)

Correspondence Address: CONNOLLY BOVE LODGE & HUTZ, LLP, P O BOX 2207, WILMINGTON, DE, 19899, US

(73) Assignee: BASF AKTIENGESELLSCHAFT, Ludwigshafen (DE)

(21) Appl. No.: 11/995,982

(22) PCT Filed: Jul. 11, 2006
(86) PCT No.: PCT/EP2006/064078

§ 371 Date: Jan. 17, 2008

(30) Foreign Application Priority Data
Jul. 19, 2005 (DE) 10 2005 034 215.9

(51) Int. Cl. C09D 123/08

(52) U.S. Cl. 524/556

(57) ABSTRACT

A method for coating surfaces using
(A) at least one ethylene copolymer wax selected from those ethylene copolymer waxes which comprise, incorporated in the form of polymerized comonomers,
   (a) from 15 to 40% by weight of at least one ethylenically unsaturated carboxylic acid and
   (b) from 60 to 85% by weight of ethylene,
   and those ethylene copolymer waxes which comprise, incorporated in the form of polymerized units,
   (a′) from 14.5 to 39.9% by weight of at least one ethylenically unsaturated carboxylic acid,
   (b′) from 60 to 79.4% by weight of ethylene and
   (c′) from 0.1 to 15% by weight of an ester of an ethylenically unsaturated carboxylic acid,
   in each case in at least partly neutralized form, and
(B) at least one further wax which differs from ethylene copolymer wax (A).

The present invention relates to a method for coating surfaces using
A) at least one ethylene copolymer wax selected from those ethylene copolymer waxes which comprise, incorporated in the form of polymerized comonomers,
   (a) from 15 to 40% by weight of at least one ethylenically unsaturated carboxylic acid and
   (b) from 60 to 85% by weight of ethylene,
      and those ethylene copolymer waxes which comprise, incorporated in the form of polymerized units,
   (a′) from 14.5 to 39.9% by weight of at least one ethylenically unsaturated carboxylic acid,
   (b′) from 60 to 79.4% by weight of ethylene
   (c′) from 0.1 to 15% by weight of an ester of an ethylenically unsaturated carboxylic acid,
      in each case in at least partly neutralized form, and
B) at least one further wax which differs from ethylene copolymer wax (A).

In many cases, it is desired to coat surfaces which are exposed to a considerable degree to environmental influences. By means of a water-repellant coating, otherwise hydrophillic surfaces are made water-repellant. Water-swellable substrates can thus be less readily attacked, and metallic substrates are less susceptible to corrosion.

Various technical possibilities are known for the purpose of coating. Thus, for example, a finish may be applied. Another method is to provide the relevant surface with a hydrophobic film.

DE 34 20 168 discloses wax dispersions for floor care, which comprise:
1. from 5 to 20% by weight of an aqueous secondary wax dispersion comprising from 5 to 40% by weight, based on the secondary wax dispersion, of an ethylene copolymer wax consisting of from 10 to 25% by weight of an α-olefinically unsaturated mono- or dicarboxylic acid having 3 to 8 carbon atoms and from 90 to 75% by weight of ethylene, having an MFI value, measured at 190° C. and 2.16 kP, of from 1 to 600 or an MFI value, measured at 160° C. and 325 g, of from 1 to 400, furthermore, from 0.1 to 5% by weight, based on the secondary wax dispersion, of alkali metal hydroxide, ammonia, alkanolamine, dialkylalkanolamine and their mixtures, and, if appropriate, from 1 to 5% by weight of a nonionic or anionic emulsifier and the remainder water to 100% by weight, based on the secondary wax dispersion, and based in each case on the total weight of the wax dispersion for floor care,
2. from 20 to 50% by weight of an aqueous primary dispersion having a solids content of from 20 to 50% by weight, where (page 4, lines 21-24) the primary dispersion is a copolymer which by itself alone is not a wax,
3. from 1 to 8% by weight of one or more plasticizers,
4. from 0.2 to 2% by weight of a leveling agent and
5. from 73.8 to 20% by weight of water.

Wax dispersions disclosed in DE 34 20 168 for floor care can, however, be further improved for coatings.

Economical hydrophobic materials are waxes, such as, for example, paraffin waxes. In order to apply hydrophobic materials, such as waxes, in the form of a film to surfaces, it is necessary to dissolve either the relevant wax or the relevant waxes in an organic solvent, such as, for example, gasoline or toluene. However, coating with the use of large amounts of organic solvent is undesirable. Attempts have therefore been made to apply paraffin wax in the form of an aqueous emulsion. Large amounts of emulsifiers (surfactants) are required for this purpose.

However, it is observed that paraffin wax films on numerous substrates, such as, for example, stones, stoneware, terracotta, metal, wood, glass and cardboard boxes, are not very stable and can easily be removed mechanically. It is furthermore observed that in many cases the effect of the coating declines sharply with time. Finally, it is observed that paraffin wax films are frequently slightly opaque and have an optically disadvantageous appearance.

It was therefore the object to provide a method for coating surfaces of substrates, such as, for example, wood, glass and cardboard boxes, which avoids the disadvantages known from the prior art. It was furthermore the object to provide coated surfaces of articles having coated surfaces.

Accordingly, the method defined at the outset was found.

According to the method according to the invention, it is possible to coat such surfaces which consist of any desired materials. Surfaces of metals, coated or uncoated, cellulose-containing substrates, textile, natural and synthetic sheets and adhesives are preferably coated.

In an embodiment of the present invention, surfaces which are coated according to the invention have a measurable hydrophilicity prior to coating. They are usually among articles which it is desired to protect from attack by water or substances dissolved or dispersed in water. Surfaces to be coated according to the invention may comprise, for example, stone, metal, including alloys of two or more metals, coated, galvanized or, preferably, uncoated. In another embodiment of the present invention, surfaces to be coated consist of cellulose-containing substrates, such as, for example, paper, board, cardboard boxes, wood, solid or particleboard, adhesive, in particular hotmelts, preferably in the cured state, finishes, in particular top coats, or glass. Surfaces comprising plastics, for example, polypropylene or polyethylene are furthermore suitable.

Articles having surfaces to be coated according to the invention may be, for example, cars in which in particular the underfloor is coatable according to the invention, and furthermore, cardboard boxes. Wooden articles having surfaces to be coated according to the invention may be, for example, buildings or parts of buildings, such as, for example, roof frameworks or terraces, and furthermore fences or benches. Stoneware and terracotta may furthermore be mentioned.

The method defined at the outset starts from at least one ethylene copolymer wax (A) in at least partly neutralized form.

Ethylene copolymer waxes (A) used according to the invention are selected from those ethylene copolymer waxes which comprise, incorporated in the form of polymerized comonomers,
(a) from 15 to 40% by weight, preferably from 19 to 35% by weight, particularly preferably from 25 to 34% by weight, of at least one ethylenically unsaturated carboxylic acid
(b) from 60 to 85% by weight, preferably from 65 to 81% by weight, particularly preferably from 66 to 75% by weight, of ethylene,
   and those ethylene copolymer waxes (A) which comprise, incorporated in the form of polymerized units,
(a′) from 14.5 to 39.9% by weight, preferably from 19 to 28% by weight, of at least one ethylenically unsaturated carboxylic acid,
(b′) from 60 to 79.4% by weight, preferably from 71.5 to 81.5% by weight, of ethylene and
(c′) from 0.1 to 15% by weight, preferably from 0.5 to 10% by weight, of at least one ester of an ethylenically unsaturated carboxylic acid.

Comonomers incorporated in the form of polymerized units are understood as meaning those proportions of comonomer which are incorporated in molecular form into the ethylene copolymer waxes used according to the invention.

Preferably, the chosen ethylenically unsaturated carboxylic acid (a) or (a′) is at least one carboxylic acid of the general formula I,

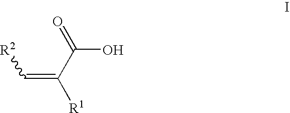

in which the variables are defined as follows:
R¹ and R² are identical or different.
R¹ is selected from hydrogen and
straight-chain and branched C₁-C₁₀-alkyl, such as, for example, methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl; particularly preferably C₁-C₄-alkyl, such as methyl, ethyl, n-propyl, isopropyl, n-butyl, isobutyl, sec-butyl and tert-butyl, in particular methyl;
R² is selected from straight-chain and branched C₁-C₁₀-alkyl, such as, for example methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, iso-hexyl, sec-hexyl, n-heptyl, n-octyl, 2-ethylhexyl, n-nonyl, n-decyl; particularly preferably C₁-C₄-alkyl such as methyl, ethyl, n-propyl, isopropyl, n-butyl, isobutyl, sec-butyl and tert-butyl, in particular methyl;

### COOH,

and very particularly preferably hydrogen.

In an embodiment of the present invention, R¹ is hydrogen or methyl. R¹ is very particularly preferably methyl.

In an embodiment of the present invention, R¹ is hydrogen and R² is COOH.

In an embodiment of the present invention R¹ is hydrogen or methyl and R² is hydrogen.

Methacrylic acid is very particularly preferably used as ethylenically unsaturated carboxylic acid (a) or (a′) of the general formula I.

If it is desired to use a plurality of ethylenically unsaturated carboxylic acids for the preparation of ethylene copolymer wax (A) used according to the invention, it is possible to use two different ethylenically unsaturated carboxylic acids (a) or (a′) of the general formula I, such as, for example, acrylic acid and methacrylic acid.

In an embodiment of the present invention, (meth) acrylic acid and maleic acid are used as ethylenically unsaturated carboxylic acid (a) or (a′) for the preparation of the ethylene copolymer wax (A) used according to the invention.

In an embodiment of the present invention, only one ethylenically unsaturated carboxylic acid (a), in particular acrylic acid or methacrylic acid, is used for the preparation of ethylene copolymer wax (A) used according to the invention.

In an embodiment of the present invention, ethylene copolymer waxes (A) chosen are those which comprise, incorporated in the form of polymerized units,
(a′) from 14.5 to 39.9% by weight, preferably from 19 to 28% by weight, of at least one ethylenically unsaturated carboxylic acid,
(b′) from 60 to 79.4% by weight, preferably from 71.5 to 81.5% by weight, of ethylene and
(c′) from 0.1 to 15% by weight, preferably from 0.5 to 10% by weight, of at least one ester of an ethylenically unsaturated carboxylic acid.

Ethylenically unsaturated carboxylic acids (a′) are understood as meaning the same ethylenically unsaturated carboxylic acids as described above.

At least one ester of an ethylenically unsaturated carboxylic acid (c′) preferably corresponds to a carboxylic ester of the general formula II.

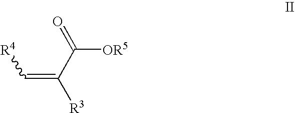

in which the variables are defined as follows:
R³ and R⁴ are identical or different.
R³ is selected from hydrogen and
straight-chain and branched C₁-C₁₀-alkyl, such as, for example, methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl, particularly preferably C₁-C₄-alkyl, such as methyl, ethyl, n-propyl, isopropyl, n-butyl, isobutyl, sec-butyl and tert-butyl, in particular methyl.
R⁴ is selected from straight-chain and branched C₁-C₁₀-alkyl such as, for example, methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, iso-hexyl, sec-hexyl, n-heptyl, n-octyl, 2-ethylhexyl, n-nonyl, n-decyl, particularly preferably C₁-C₄-alkyl, such as methyl, ethyl, n-propyl, isopropyl, n-butyl, isobutyl, sec-butyl and tert-butyl, in particular methyl;
and very particularly preferably hydrogen.
R⁵ is selected from
straight-chain and branched C₁-C₁₀-alkyl, such as, for example, methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl, particularly preferably C₁-C₄-alkyl, such as methyl, ethyl, n-propyl, isopropyl, n-butyl, isobutyl, sec-butyl and tert-butyl, in particular methyl; C₃-C₁₂-cycloalkyl such as cyclopropyl, cyclobutyl, cyclopentyl, cyclohexyl, cycloheptyl, cyclooctyl, cyclononyl, cyclodecyl, cycloundecyl and cyclododecyl; cyclopentyl, cyclohexyl and cycloheptyl are preferred.

In an embodiment of the present invention, R³ is hydrogen or methyl. R³ is very particularly preferably hydrogen.

In an embodiment of the present invention, R³ and R⁴ are hydrogen.

R⁵ is very particularly preferably methyl.

Methyl acrylate is very particularly preferably used as the ester of an ethylenically unsaturated carboxylic acid of the general formula II.

If it is desired to use a plurality of unsaturated carboxylic esters (c′) for the preparation of ethylene copolymer wax (A) used according to the invention, it is possible to use, for example, two different ethylenically unsaturated carboxylic esters of the general formula II, such as, for example methyl acrylate and methyl methacrylate.

In an embodiment of the present invention, methyl(meth)acrylate is used as the ethylenically unsaturated carboxylic ester of the general formula II for the preparation of ethylene copolymer wax (A) used according to the invention.

In an embodiment of the present invention, only one ethylenically unsaturated carboxylic ester and only one ethylenically unsaturated carboxylic acid, in particular acrylic acid or methacrylic acid and methyl(meth)acrylate, are used for the preparation of ethylene copolymer wax (A) used according to the invention.

In an embodiment of the present invention, up to 0.5 part by weight, based on the sum of the comonomers described above, of further comonomers are incorporated in the form of polymerized units for the preparation of ethylene copolymer wax (A) used according to the invention. Further comonomers may be selected, for example, from vinyl acetate and isobutene.

In another embodiment of the present invention, no further comonomers are incorporated in the form of polymerized units for the preparation of ethylene copolymer wax (A) used according to the invention.

In an embodiment of the present invention, ethylene copolymer wax (A) used according to the invention has a melt mass-flow rate (MFR) in the range from 1 to 50 g/10 min, preferably from 5 to 20 g/10 min, particularly preferably from 7 to 15 g/10 min, measured at 160° C. and a load of 325 g according to EN ISO 1133. Its acid number is usually from 100 to 300 mg KOH/g of wax, preferably from 110 to 230 mg KOH/g of wax, determined according to DIN 53402.

In an embodiment of the present invention, ethylene copolymer wax (A) used according to the invention has a kinematic melt viscosity ν of at least 45 000 mm²/s, preferably of at least 50 000 mm²/s.

In an embodiment of the present invention, the melting range of ethylene copolymer wax (A) used according to the invention is in the range from 50 to 110° C., preferably in the range from 60 to 90° C., determined by DSC according to DIN 51007.

In an embodiment of the present invention, the melting range of ethylene copolymer wax (A) used according to the invention may be broad and may relate to a temperate range from at least 7 to not more than 20° C., preferably from at least 10° C. to not more than 15° C.

In another embodiment of the present invention, the melting point of ethylene copolymer wax (A) used according to the invention is sharp and is in a temperature range of less than 2° C., preferably less than 1° C., determined according to DIN 51007.

The density of ethylene copolymer wax (A) used according to the invention is usually from 0.89 to 1.10 g/cm³, preferably from 0.92 to 0.99 g/cm³, determined according to DIN 53479.

Ethylene copolymer waxes (A) used according to the invention may be alternating copolymers or block copolymers or preferably random copolymers.

Ethylene copolymer waxes (A) used according to the invention and obtained from ethylene and ethylenically unsaturated carboxylic acids and, if appropriate, ethylenically unsaturated carboxylic esters can advantageously be prepared by free radical copolymerization under high pressure conditions, for example in stirred high-pressure autoclaves or in high-pressure tubular reactors. The preparation in stirred high-pressure autoclaves is preferred. Stirred high-pressure autoclaves are known per se and a description is to be found in Ullmann's Encyclopedia of Industrial Chemistry, 5th edition, keywords: Waxes, Vol. A 28 page 146 et. seq., Verlag Chemie Weinheim, Basle, Cambridge, N.Y., Tokyo, 1996. In them, the length/diameter ratio is predominantly in ranges from 5:1 to 30:1, preferably from 10:1 to 20:1. The high-pressure tubular reactors which can likewise be used are also to be found in Ullmann's Encyclopedia of Industrial Chemistry, 5th edition, keywords: Waxes, vol. A 28, page 146 et seq., Verlag Chemie Weinheim, Basle, Cambridge, N.Y., Tokyo, 1996.

Suitable pressure conditions for the polymerization are from 500 to 4000 bar, preferably from 1500 to 2500 bar. Conditions of this type are also referred to below as high-pressure. The reaction temperatures are in the range from 170 to 300° C., preferably in the range from 195 to 280° C.

The polymerization can be carried out in the presence of a regulator. The regulator used is, for example, hydrogen or at least one aliphatic aldehyde or at least one aliphatic ketone of the general formula III.

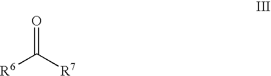

or mixtures thereof.

The radicals R⁶ and R⁷ are identical or different and are selected from

hydrogen;
C₁-C₆-alkyl such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, particularly preferably C₁-C₄-alkyl such as methyl, ethyl, n-propyl, isopropyl, n-butyl, isobutyl, sec.-butyl and tert-butyl;
C₃-C₁₂-cycloalkyl such as cyclopropyl, cyclobutyl, cyclopentyl, cyclohexyl, cycloheptyl, cyclooctyl, cyclononyl, cyclodecyl, cycloundecyl and cyclododecyl; cyclopentyl, cyclohexyl and cycloheptyl are preferred.

In a preferred embodiment the radicals R⁶ and R⁷ are covalently bonded to one another with formation of a 4- to 13-membered ring. Thus, R⁶ and R⁷ together may be, for example: —(CH₂)₄—, —(CH₂)₅—, —(CH₂)₆, —(CH₂)₇—, —CH(CH₃)—CH₂—CH₂—CH(CH₃)— or —CH(CH₃)—CH₂—CH₂—CH₂—CH(CH₃)—.

Examples of suitable regulators are furthermore alkylaromatic compounds, for example toluene, ethylbenzene or one or more isomers of xylene. Examples of suitable regulators are furthermore paraffins, such as, for example, isododecane (2,2,4,6,6-pentamethylheptane) or isooctane.

The conventional free radical initiators, such as, for example, organic peroxides, oxygen or azo compounds, may be used as initiators for the free radical polymerization. Mixtures of a plurality of free radical iniators are also suitable.

Suitable peroxides, selected from commercially available substances, are
didecanoyl peroxide, 2,5-dimethyl-2,5-di(2-ethylhexanoylperoxy)hexane, tert-amyl peroxy-2-ethylhexanoate, dibenzoyl peroxide, tert-butyl peroxy-2-ethylhexanoat, tert-butylperoxydiethylacetate, tert-butyl peroxydiethylisobutyrate, 1,4-di(tert-butylperoxycarbonyl)cyclohexane as an isomer mixture, tert-butyl perisononanoate, 1,1-di(tert-butylperoxy)-3,3,5-trimethylcyclohexane, 1,1-di(tert-butylperoxy)cyclohexane, methyl isobutyl ketone peroxide, tert-butyl peroxyisopropylcarbonate, 2,2-di(tert-butylperoxy)butane or tert-butyl peroxyacetate;
tert-butylperoxybenzoate, di-tert-amylperoxide, dicumyl peroxide, the isomeric di(tert-butylperoxyisopropyl)benzenes, 2,5-dimethyl-2,5-di-tert-butylperoxyhexane, tert-butyl cumyl peroxide, 2,5-dimethyl-2,5-di(tert-butylperoxy)hex-3-yne, di-tert-butyl peroxide, 1,3-diisopropylbenzene monohydroperoxide, cumol hydroperoxide or tert-butyl hydroperoxide; or
dimeric or trimeric ketone peroxides of the general formulae IV a to IV c.

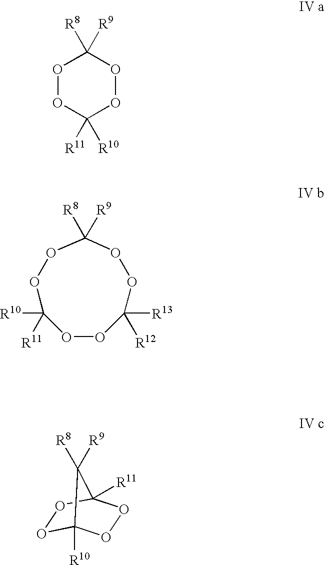

The radicals R⁸ to R¹³ are identical or different and are selected from

C₁-C₈-alkyl, such as methyl, ethyl, n-propyl, isopropyl, n-butyl, sec-butyl, isobutyl, tert-butyl, n-pentyl, sec-pentyl, isopentyl, n-hexyl, n-heptyl, n-octyl; preferably linear C₁-C₆-alkyl, such as methyl, ethyl, n-propyl, n-butyl, n-pentyl, n-hexyl, particularly preferably linear C₁-C₄-alkyl, such as methyl, ethyl, n-propyl or n-butyl; methyl and ethyl are very particularly preferred;
C₆-C₁₄-aryl, such as phenyl, 1-naphthyl, 2-naphthyl, 1-anthryl, 2-anthryl, 9-anthryl, 1-phenanthryl, 2-phenanthryl, 3-phenanthryl, 4-phenanthryl and 9-phenanthryl, preferably phenyl, 1-naphthyl and 2-naphthyl, particularly preferably phenyl.

Peroxides of the general formulae IV a to IV c and processes for their preparation are disclosed in EP-A 0 813 550.

Particularly suitable peroxides are di-tert-butyl peroxide, tert-butyl peroxypivalate, tert-butyl peroxyisononanoate and dibenzoyl peroxide or mixtures thereof. Azobisisobutyronitrile (“AIBN”) may be mentioned by way of example as an azo compound. Free radical iniators are metered in amounts customary for polymerizations.

So-called desensitizers are added to numerous commercially available organic peroxides before they are sold, in order to make them easier to handle. For example, white oil or hydrocarbons, such as, in particular, isododecane, are suitable as desensitizers. Under the conditions of the high-pressure polymerization, such desensitizers can have a molecular weight-regulating effect. In the context of the present invention, the use of molecular weight-regulators is to be understood as meaning the additional use of further molecular weight regulators over and above the use of the desensitizers.

The ratio of the comonomers in the metering usually does not correspond exactly to the ratio of the units in the ethylene copolymer waxes used according to the invention, because ethylenically unsaturated carboxylic acids are generally more readily incorporated into ethylene copolymer waxes than ethylene.

The comonomers are usually metered together or separately.

The comonomers can be compressed to the polymerization pressure in a compressor. In another embodiment of the method according to the invention, the comonomers are first brought with the aid of a pump to an elevated pressure of, for example, from 150 to 400 bar, preferably from 200 to 300 bar and in particular 260 bar, and then to the actual polymerization pressure by means of a compressor.

The polymerization can optionally be carried out in the absence or in the presence of solvents, mineral oils, white oil and other solvents which are present during the polymerization in the reactor and are used for desensitizing the free radical initiator or iniators not being considered as solvents in the context of the present invention. Suitable solvents are, for example, toluene, isododecane and isomers of xylene.

Ethylene copolymer wax (A) used according to the invention is at least partly neutralized, for example with hydroxide and/or carbonate and/or bicarbonate of alkali metal, for example, sodium hydroxide, potassium hydroxide, sodium carbonate, potassium carbonate, sodium bicarbonate, potassium bicarbonate, lithium hydroxide, or preferably with one or more amines, such as, for example, ammonia and organic amines, such as, for example, alkylamines, N-alkylethanolamines, alkanolamines and polyamines. The following may be mentioned by way of example for alkylamines: triethylamine, diethylamine, ethylamine, trimethylamine, dimethylamine, methylamine, piperidine and morpholine. Preferred amines are monoalkanolamines, N,N-dialkylalkanolamines, N-alkylalkanolamines, dialkanolamines, N-alkylalkanolamines and trialkanolamines having in each case 2 to 18 carbon atoms in the hydroxyalkyl radical and, if appropriate, in each case, 1 to 6 carbon atoms in the alkyl radical, preferably 2 to 6 carbon atoms in the alkanol radical and, if appropriate, 1 or 2 carbon atoms in the alkyl radical. Ethanolamine, diethanolamine, triethanolamine, methyldiethanolamine, n-butyldiethanolamine, N,N-dimethylethanolamine and 2-amino-2-methylpropan-1-ol are very particularly preferred. Ammonia and N,N-dimethylethanolamine are very particularly preferred. The following may be mentioned by way of example as polyamines: ethylenediamine, tetramethylethylenediamine (TMEDA), diethylenetriamine and triethylenetetramine.

In an embodiment of the present invention, ethylene copolymer wax (A) used according to the invention is partly neutralized, i.e. at least one third, preferably at least 60 mol-%, of the carboxyl group and, for example, up to 99 mol-% of the ethylene copolymer wax or waxes (A) are neutralized.

In an embodiment of the present invention, ethylene copolymer wax (A) used according to the invention is quantitatively neutralized.

Furthermore, the method according to the invention is carried out starting from at least one further wax (B) which differs from ethylene copolymer wax (A) and is also referred to as wax (B) in the context of the present invention.

Examples of suitable waxes (B) are natural waxes, such as, for example, beeswax, carnauba wax, cadelilla wax, bark wax, ouricouri wax, sugarcane wax, montanic acid and ester wax, crude montan wax, and in particular synthetic waxes, such as, for example, Fischer-Tropsch-Waxes, high density polyethylene waxes, for example prepared with the aid of Ziegler-Natta catalysts or metallocene catalysts, and furthermore partly oxidized high density polyethylene waxes having an acid number in the range of 1 to 150 mg KOH/g of wax, determined according to DIN 53402, high density polyethylene waxes comprising not only homopolymer waxes of ethylene but also copolymers of polyethylene with altogether up to 20% by weight of comonomer, such as, for example, propylene, 1-butene, 1-pentene, 1-hexene, 1-octene, 1-decene or 1-dodecene, and in particular, paraffin waxes and isoparaffin waxes, for example crude paraffins waxes (crude paraffin), slack wax raffinates, deoiled crude paraffins (deoiled paraffin waxes), semi refined or completely refined paraffins (semi refined or completely refined paraffin waxes) and bleached paraffins (bleached paraffin waxes). Paraffin waxes in relation to the present invention are understood as meaning in particular paraffins which are solid at room temperature and melt in the range from 40 to 80° C., preferably from 50 to 75° C. i.e. saturated hydrocarbons, branched or straight-chain, cyclic or preferably acyclic, individually or preferably as a mixture of a plurality of saturated hydrocarbons. Paraffin waxes in relation to the present invention are preferably composed of saturated hydrocarbons having 18 to 45 carbon atoms, and isoparaffins in relation to the present invention are preferably composed of saturated hydrocarbons having 20 to 60 carbon atoms.

In a special embodiment of the present invention, a mixture of paraffin wax and partly oxidized polyethylene wax, obtainable, for example, by partial oxidation of polyethylene wax prepared in the high pressure or in the low pressure process and having an acid number in the range from 1 to 150 mg KOH/g of wax, determined according to DIN 53402, is used as wax (B) which differs from ethylene copolymer wax (A). If it is desired to use a mixture of paraffin wax and partly oxidized high density polyethylene wax having an acid number in the range from 1 to 150 mg KOH/g of wax, weight ratios in the range from 1:99 to 99:1 are suitable, in particular from 1:9 to 9:1.

In a special embodiment of the present invention, a mixture of paraffin wax and montan ester wax, for example in a weight ratio in the range of from 1:99 to 99:1, in particular from 1:9 to 9:1, is used as wax (B) which differs from ethylene copolymer wax (A).

For carrying out the method according to the invention, at least one surfactant (C), preferably a nonionic surfactant, may furthermore optionally be used.

Customary nonionic surfactants are, for example, ethoxylated mono-, di- and tri-alkylphenols (degree of ethoxylation: 3 to 50, alkyl radical: C₄-C₁₂), ethoxylated fatty alcohols (degree of ethoxylation: 3 to 80, preferably 10 to 20; alkyl radical: C₈-C₃₆, preferably C₁₆-C₁₈) and ethoxylated oxo alcohols (degree of ethoxylation: 3 to 80; alkyl radical: C₉-C₃₅). Examples are the Lutensol® brands from BASF Aktiengesellschaft or the Triton® brands from Union Carbide.

For carrying out the method according to the invention it is furthermore possible optionally to use at least one solid in particulate form (D), preferably having a mean diameter in the range from 10 nm to 300 nm, particularly preferably in the range from 50 to 250 nm. Particularly suitable examples of solids in particulate form (D) are alumina, silica gel, in particular pyrogenic silica gel, aluminosilicates, polyethylene and polypropylene.

In a special embodiment of the present invention, at least one montan wax (E), preferably at least one montanic acid wax, particularly preferably a resin-free montanic acid wax, can be used for carrying out the coating according to the invention, montan wax (E) and in particular montanic acid wax preferably being used in at least partly neutralized form and bases suitable for at least partial neutralization being selected from the abovementioned bases.

In an embodiment of the present invention, an aqueous dispersion or emulsion which, in addition to ethylene copolymer wax (A) in at least partly neutralized form and at least one wax (B) which differs from ethylene copolymer wax (A) and, if appropriate, surfactant (C), comprises, if appropriate, at least one solid in particulate form (D) and, if appropriate, at least one montan wax (E) is used for carrying out the method according to the invention.

For carrying out the method according to the invention, it is usual to proceed in such a way that the surface to be coated is treated, preferably covered, with at least one aqueous dispersion or emulsion which comprises at least one ethylene copolymer wax (A), at least one further wax (B) which differs from ethylene copolymer wax (A), optionally at least one preferably nonionic surfactant (C), optionally at least one solid in particulate form (D) and optionally at least one montan wax (E).

In an embodiment of the present invention, aqueous dispersion or emulsion used according to the invention has a solids content in the range from 1 to 70% by weight, preferably from 10 to 65% by weight.

In an embodiment of the present invention, aqueous dispersion or emulsion used according to the invention comprises:

from 0.1 to 99.9% by weight, preferably from 1 to 99% by weight, particularly preferably from 30 to 70% by weight, of ethylene copolymer wax (A),
from 0.1 to 99.9% by weight, preferably from 1 to 99% by weight, particularly preferably from 30 to 70% by weight, of further wax (B) which differs from ethylene copolymer wax (A),
from 0 to 20% by weight, preferably from 0.1 to 15% by weight, of surfactant (C),
from 0 to 15% by weight, preferably from 0.1 to 10% by weight, of solid in particulate form (D),
from 0 to 20% by weight, preferably from 0.1 to 15% by weight, of montan wax (E),
data in % by weight being based in each case on the solids content of aqueous dispersion or emulsion used according to the invention.

The method according to the invention can be carried out, for example, in such a way that ethylene copolymer wax (A), further wax (B) which differs from ethylene copolymer wax (A), if appropriate surfactant (C), if appropriate solid in particulate form (D) and, if appropriate, montan wax (E), for example in the form of an aqueous emulsion or dispersion, is applied to the surface to be coated. The application can be effected, for example, by coating, such as spraying on, application using a knife coater, brushing on or immersion.

The application is preferably effected in the form of a preferably cohesive film which may have a thickness of, for example, from 1 to 300 μm, preferably from 5 to 100 μm, when wet.

After the application, drying can be carried out, for example thermally at temperatures in the range from 35 to 110° C. However, it is also possible to effect drying at room temperature. It is also possible to effect drying by freeze drying methods known per se.

After the drying, the applied preferably cohesive film may have, for example, a thickness in the range of 0.5 to 75 μm, preferably 1 to 40 μm and particularly preferably up to 25 μm.

The present invention furthermore relates to the use of ethylene copolymer waxes (A) by the above-described method according to the invention.

The present invention furthermore relates to coated surfaces obtainable by the above-described method according to the invention. Coated surfaces according to the invention are distinguished by overall advantageous properties, for example, good water-repellant behavior, good optical properties and high film strength, in particular with regard to the stability, especially by good stability or adhesion to the respective coated article.

In many cases, in particular if coated surfaces according to the invention comprise wood, it is observed that scratches in the coating according to the invention heal in the course of time. A certain self-healing effect which increases the life of coatings according to the invention is thus observed.

A further aspect of the present invention relates to articles comprising at least one coated surface according to the invention. Articles according to the invention are distinguished, for example, by high stability to water or substances dissolved in water.

The present invention furthermore relates to aqueous formulations, for example dispersions and emulsions, comprising at least one ethylene copolymer wax (A) and at least one further wax (B) which differs from ethylene copolymer wax (A), and, if appropriate, at least one surfactant (C). Aqueous formulations according to the invention may comprise at least one solid in particulate form (D) and/or at least one montan wax (E).

In an embodiment of the present invention, aqueous formulation according to the invention has a solids content in the range from 1 to 70% by weight, preferably from 10 to 65% by weight.

In an embodiment of the present invention, aqueous formulation according to the invention comprises:

from 0.1 to 99.9% by weight, preferably from 1 to 99% by weight, particularly preferably from 10 to 70% by weight, of ethylene copolymer wax (A),
from 0.1 to 99.9% by weight, preferably from 1 to 99% by weight, particularly preferably from 10 to 70% by weight, of further wax (B) which differs from ethylene copolymer wax (A),
from 0 to 20% by weight, preferably from 0.1 to 15% by weight, of surfactant (C),
from 0 to 15% by weight, preferably from 0.1 to 10% by weight of solid in particulate form (D),
from 0 to 20% by weight, preferably from 0.1 to 15% by weight, of montan wax (E),
data in % by weight being based in each case on the solids content of aqueous formulation according to the invention.

In an embodiment of the present invention, ethylene copolymer wax (A) is selected from those ethylene copolymer waxes which comprise, incorporated in the form of polymerized comonomers,
(a) from 15 to 40% by weight, preferably from 19 to 35% by weight, particularly preferably from 25 to 34% by weight, of at least one ethylenically unsaturated carboxylic acid and
(b) from 60 to 85% by weight, preferably from 65 to 81% by weight, particularly preferably from 66 to 75% by weight, of ethylene,
   and those ethylene copolymer waxes which comprise, incorporated in the form of polymerized units,
(a′) from 14.5 to 39.9% by weight, preferably from 19 to 28% by weight, of at least one ethylenically unsaturated carboxylic acid,
(b′) from 60 to 79.4% by weight, preferably from 71.5 to 81.5% by weight, of ethylene and
(c′) from 0.1 to 15% by weight, preferably from 0.5 to 10% by weight, of at least one ester of an ethylenically unsaturated carboxylic acid.

In an embodiment of the present invention, formulation according to the invention may comprise more basic substance or basic substances, in particular amine, than required for complete neutralization of ethylene copolymer wax (A), for example an excess of up to 100 mol-%, preferably up to 50 mol-%.

Aqueous formulations according to the invention are particularly suitable for carrying out the method according to the invention.

The present invention furthermore relates to processes for the preparation of aqueous formulations according to the invention, also referred to below as preparation process according to the invention.

The preparation process according to the invention can be carried out, for example, by mixing ethylene copolymer wax (A) in at least partly neutralized form, at least one further wax (B) which differs from ethylene copolymer wax (A), water and, if appropriate, at least one surfactant (C) in any desired sequence.

In an embodiment of the present invention, the preparation process according to the invention is carried out by mixing ethylene copolymer wax (A) in at least partly neutralized form, at least one further wax (B) which differs from ethylene copolymer wax (A), water and, if appropriate, at least one surfactant (C) at a temperature which is below the melting point of wax (B).

In the abovementioned embodiment of the preparation process according to the invention, the mixing can be effected, for example, by rapid stirring, for example at from 5 000 to 20 500 rpm, preferably at least 8 000 rpm using Ultra Turrax stirrers.

For carrying out the abovementioned embodiment of the preparation process according to the invention, wax (B) which differs from ethylene copolymer wax (A) is preferably used in the form of an aqueous dispersion which comprises one or more waxes (B) and one or more preferably nonionic surfactants (C).

After the abovementioned embodiment of the preparation process according to the invention has been carried out, formulations according to the invention having a bimodal particle diameter distribution can preferably be obtained.

In another variant of the present invention, the preparation process according to the invention is carried out by mixing ethylene copolymer wax (A) in at least partly neutralized form with at least one further wax (B) which differs from ethylene copolymer wax (A) and with water at a temperature which is above the melting point of wax (B) and ethylene copolymer wax (A). The use of surfactant (C) can thus be dispensed with.

The abovementioned variant can be carried out, for example, by mixing, in particular emulsifying, ethylene copolymer wax (A) in at least partly neutralized form, which has been preheated to a temperature in the range of 60 to 98° C., with at least one molten wax (B) which differs from ethylene copolymer wax (A), in water.

After the abovementioned variant of the preparation process according to the invention has been carried out, formulations according to the invention having a monomodal particle diameter distribution can preferably be obtained.

In another embodiment of the present invention, the preparation process according to the invention is carried out by mixing and in particular emulsifying ethylene copolymer wax (A) in unneutralized form with at least one further wax (B), in molten form, which differs from ethylene copolymer wax (A), in water at a temperature which is above the melting point of wax (B), and effecting at least partial neutralization with base simultaneously with the mixing or emulsification or thereafter.

The abovementioned variant of the preparation process according to the invention is carried out starting from one or more of the above-described ethylene copolymer waxes (A) in unneutralized form. This wax or these waxes is or are placed in a vessel, for example a flask, an autoclave or a kettle, wax (B), water and one or more bases are added, and ethylene copolymer wax (A), water and one or more bases and wax (B) are heated, the sequence of the addition of water and of the addition of base, wax (B) and further constituents being arbitrary. If the temperature is above 100° C., it is advantageous to employ elevated pressure and to choose the vessel appropriately. The resulting emulsion is homogenized, for example by mechanical or pneumatic stirring or by shaking. Heating is effected to a temperature above the melting point of wax (B) and advantageously to a temperature of above the melting point of ethylene copolymer wax (A). Advantageously, heating is effected to a temperature which is at least 5° C., particularly advantageously to a temperature which is at least 10° C., above the melting point of ethylene copolymer wax (A).

If a plurality of different ethylene copolymer waxes (A) are used, heating is effected to a temperature which is above the melting point of the ethylene copolymer wax (A) melting at the highest temperature. When a plurality of different ethylene copolymer waxes (A) is used, heating is advantageously effected to a temperature which is at least 5° C. above the melting point of the ethylene copolymer wax (A) melting at the highest temperature. When a plurality of different ethylene copolymer waxes (A) is used, heating is particularly advantageously effected to a temperature which is at least 10° C. above the melting point of the ethylene copolymer wax (A) melting at the highest temperature.

The aqueous formulation thus prepared is then allowed to cool.

In another variant of the present invention, the preparation process according to the invention is carried out by dispersing ethylene copolymer wax (A) in unneutralized form with at least one further wax (B), at least one base and water, for example in a mill, in particular a ball mill, or a shaking apparatus, for example a Skandex. In this variant, preferably no further surfactant (C) is used.

For carrying out the abovementioned variant, milling assistants, such as, for example, glass or steel balls, may also be added.

When carrying out the abovementioned variant of the present invention, the mixture of ethylene copolymer wax (A), wax (B), base and water may heat up to such an extent that, for example, the melting point of wax (B) is exceeded.

Aqueous formulations according to the invention are distinguished by a good shelf life and can be readily used in the above-described method according to the invention for coating surfaces.

The invention is explained by working examples.

### WORKING EXAMPLES

### General

For determining the hydrophobicity, the contact angle with the water was determined on the basis of DIN EN 828:1997. For evaluating the experiments (sessile drop), the tangent method was used.

### 1. Preparation of Ethylene Copolymer Wax

Ethylene and methacrylic acid were copolymerized in a high-pressure autoclave as described in the literature (M. Buback et al., Chem. Ing. Tech. 1994, 66, 510). For this purpose, ethylene (12.0 kg/h) was fed into the high-pressure autoclave under the reaction pressure of 1700 bar. Separately therefrom, the amount of methacrylic acid stated in table 1 was first compressed to an intermediate pressure of 260 bar and then fed continuously into the high-pressure autoclave under the reaction pressure of 1700 bar with the aid of a further compressor. Separately therefrom, the amount of initiator solution stated in table 1 and consisting of tert-butyl peroxypivalate (in isododecane, for concentration, cf. table 1) was fed continuously into the high-pressure autoclave under the reaction pressure of 1700 bar. Separately therefrom, the amount of regulator stated in table 1 and consisting of propionaldehyde in isododecane, for concentration, cf. table 1, was first compressed to an intermediate pressure of 260 bar and then fed continuously into the high-pressure autoclave under the reaction pressure of 1700 bar with the aid of a further compressor. The reaction temperature was about 220° C. Ethylene copolymer wax (A) according to the invention, having the analytical data shown in table 2, was obtained.

TABLE 1
Preparation of ethylene copolymer waxes used according to the invention

| | | | | | PA in | | PO | | Conversion | Discharge |
|---|---|---|---|---|---|---|---|---|---|---|
| | T_{Reactor} | Ethylene | MAA | MAA | ID | | in ID | | [% | ECW |
| No. | [° C.] | [kg/h] | [l/h] | [kg/h] | [ml/h] | c(PA) | [l/h] | c(PO) | by wt] | [kg/h] |
| A.1 | 220 | 12 | 1.09 | 1.11 | 30 | 20 | 2.16 | 0.09 | 23 | 3.0 |
| A.2 | 220 | 12 | 1.01 | 1.03 | 600 | 25 | 2.10 | 0.07 | 25 | 3.2 |
| A.3 | 219 | 12 | 1.03 | 1.05 | — | — | 2.01 | 0.13 | 26 | 3.4 |
| A.4 | 199 | 12 | 1.07 | 1.09 | — | — | 1.53 | 0.07 | 18 | 2.4 |
| A.5 | 200 | 12 | 0.72 | 0.71 | — | — | 1.18 | 0.07 | 18 | 2.3 |
| A-V6 | 220 | 12 | 0.53 | 0.56 | — | — | 2.4 | 0.05 | 22 | 2.8 |

T_{Reactor} is to be understood as meaning the maximum internal temperature of the high-pressure autoclave.

Abbreviations: MAA: methacrylic acid, PA: propionaldehyde, ID: isododecane (2,2,4,6,6-pentamethylheptane), PA in ID: solution of propionaldehyde in isododecane, total volume of the solution.
PO: tert-butyl peroxypivalate, ECW: ethylene copolymer wax
c(PA): Concentration of PA in ID in percent by volume
c(PO): Concentration of PO in ID in mol/l

The conversion is based on ethylene and is stated in % by weight.

The ethylene copolymer wax A-V6 is a comparative example.

TABLE 2
Analytical data of ethylene copolymer waxes (A)
used according to the invention

| | Content of | Content of | Acid no. | | | |
|---|---|---|---|---|---|---|
| | ethylene | MAA | [mg kOH/g | ν | Tₘₑₗₜ | ρ |
| No. | [% by wt.] | [% by wt.] | ECW] | [mm²/s] | [° C.] | [g/cm³] |
| A.1 | 71.9 | 28.1 | 183 | 50 000 | 65-80 | n.d. |
| A.2 | 73.4 | 26.6 | 173 | 50 000 | 65-80 | n.d. |
| A.3 | 73.6 | 26.4 | 172 | 68 000 | 70-80 | n.d. |
| A.4 | 61.5 | 38.5 | 251 | 77 000 | 65-75 | 0.990 |
| A.5 | 72.8 | 27.2 | 170 | n.d. | 79.3 | 0.961 |
| A-V6 | 84.7 | 15.3 | 100.5 | 70 000 | 65-80 | 0.953 |

The MFR of ethylene copolymer wax A.5 was 10.3 g/10 min, determined at a load of 325 g at a temparature of 160° C.
n.d.: not determined.

“Content” is to be understood as meaning the proportion of ethylene or MAA incorporated in the form of polymerized units in the respective ethylene copolymer wax.

ν: dynamic melt viscosity, measured at 120° C. according to DIN 51562.

The content of ethylene and methacrylic acid in the ethylene copolymer waxes used according to the invention was determined by NMR spectroscopy or by titration (acid no). The acid number of the ethylene copolymer waxes used according to the invention were determined titrimetrically according to DIN 53402. The KOH consumption corresponds to the methacrylic acid content in the ethylene copolymer wax.

The density was determined according to DIN 53479. The melting range was determined by DSC (differential scanning calorimetry, differential thermal analysis) according to DIN 51007.

### 2. Preparation of Dispersions and Comparative Experiment

The amount ethylene copolymer wax according to example 1 which is stated in table 3 was initially taken in a 2 liter autoclave with an anchored stirrer. The amounts of demineralized water stated in table 3 and the amine stated in table 3 were added and heated to 120° C. with stirring. After 15 minutes at 1200, cooling was effected to room temperature in the course of 15 minutes. The aqueous dispersions, WD1, WD2, WD3-V and WD4-V were obtained.

TABLE 3
Preparation of dispersions

| | | Amount | | Amount | |
|---|---|---|---|---|---|
| | ECW | of ECW | | of amine | Amount of |
| No. | No. | [g] | Amine | [g] | water [g] |
| WD1 | A.5 | 25.0 | NH₃ | 3.4 | 71.6 |
| WD2 | A.5 | 20.7 | (CH₃)₂NCH₂CH₂OH | 3.5 | 75.8 |
| WD3-V | A-V6 | 25.0 | NH₃ | 3.4 | 71.6 |
| WD4-V | A-V6 | 20.7 | (CH₃)₂NCH₂CH₂OH | 3.5 | 75.8 |

The “amount of NH₃” is based on the amount of 25% by weight aqueous ammonia solution.

### 3. Preparation of Formulations According to the Invention

In a 250 ml beaker with UltraTurrax, the amount of ethylene copolymer wax (A) in neutralized form according to example WD1 or WD2, stated in table 4, was initially taken and heated to 80° C. The amounts of demineralized water stated in table 4 were added and heated to 80° C. with stirring on a water bath. Paraffin wax (straight-chain, melting range 65-70° C., average number of carbon atoms per molecule: 40) (B.1) in molten form was then added. A mixture was obtained. The water bath was removed, and the mixture was stirred with the Ultra Turrax at 9500 rpm until the temperature had reached 45° C. Formulation according to the invention as shown in table 4 was obtained.

For the preparation of formulation F3 according to the invention, the procedure was as described above but 12% by weight of a pyrogenic silica gel (D.1) (primary particle diameter: 7 nm, mean particle diameter 200 nm) were stirred into the molten paraffin wax (B.1) and the mixture of (B.1) and (D.1) thus obtainable was added to (WD-1).

TABLE 4
Preparation of formulations according to the invention

| | ECW | Aqueous dispersion | (B.1) | (C.1) | (D.1) | Additional |
|---|---|---|---|---|---|---|
| No. | No. | used [g] | [g] | [g] | [g] | water [g] |
| F1 | (A.5) | WD1 [80] | 20 | — | — | — |
| F2 | (A.5) | WD2 [80] | 20 | — | — | — |
| F3 | (A.5) | WD1 [80] | 17.6 | 10 | 2.4 | — |
| V-F4 | — | — | 30 | 10 | — | 60 |

Note:
the surfactant (C.1) used was a C₁₆-C₁₈ fatty alcohol mixture reacted with 7 equivalents of ethylene oxide (molar ratio 1:1).

The dispersions F1 and F2 according to the invention were each stored at room temperature. They were in a dense, highly foamed state having a homogeneous appearance even after a storage time of 24 hours. Only after over a week was phase separation observed and the paraffin wax floated on the top.

### 4. Coating of Glass

### General Method:

A film of formulation according to the invention as shown in table 4 was applied to a glass sheet with the aid of a knife coater. The wet film had a thickness of 60 μm in each case. Thereafter, drying was initiated for 30 minutes at a drying temperature according to table 5 and the quality of the film was assessed.

TABLE 5
Coating of glass

| | Drying at 60° C. | | | Drying at 90° C. | | | |
|---|---|---|---|---|---|---|---|
| | | Contact angle | | | Contact | | |
| For- | | [°] | | | angle [°] | | |
| mulation | Gloss | Left | Right | Gloss | Left | Right | Remarks |
| Glass | 115 | 30.4 | 30.3° | n.d. | n.d. | n.d. | — |
| sheet | | | | | | | |
| WD1 | 111 | 90.2 | 86.6 | 112 | 90.5 | 85.5 | |
| F1 | 53 | 111.3 | 111.4° | 44 | 111.7 | 111.7 | Cohesive, |
| | | | | | | | smudge-proof |
| F2 | 52 | 109.3 | 109.4° | 47 | 112.7 | 112.7 | Cohesive, |
| | | | | | | | smudge-proof |
| F3 | 10 | 107.0 | 107.2 | n.d. | n.d. | n.d. | Cohesive, |
| | | | | | | | smudge-proof |
| V-F4 | 46 | 94.9 | 95.0 | n.d. | n.d. | n.d. | Cohesive, not |
| | | | | | | | smudge-proof, |
| | | | | | | | opaque |

Note:
The gloss was always assessed at 85°. The data of an uncoated glass sheet are also stated as a reference. A high gloss is undesirable.
n.d.: not determined.

### 5. Preparation of Formulation According to the Invention by Dispersion in a Shaking Apparatus and Coating of Glass

A mixture was prepared by mixing

40 g of ethylene copolymer wax A.5
6.8 g of N,N-dimethyl ethanolamine

### 40 g of (B.1)

113.2 g of distilled water

The mixture thus obtained was dispersed in a 500 ml polyethylene bottle in a shaking apparatus of the Skandex type with 900 g of steel balls (diameter 3 mm) for one hour and 45 minutes. The mixture reached a temperature of 90° C. Aqueous formulation F.5 according to the invention was obtained.

Aqueous formulation F.5 according to the invention was stored over a period of one week at room temperature. After a storage time of 12 hours and also after 72 hours, it was a highly viscous dispersion which had a visually uniform appearance and on which a small amount of foam was to be observed. Even after a storage time of one week, it was a highly viscous dispersion which had a visually uniform appearance but on which foam was no longer to be observed.

A film of formulation F.5 according to the invention was applied to a glass sheet with the aid of a knife coater. The wet film had a thickness of 60 μm. Thereafter, drying was effected for 30 minutes at a drying temperature according to table 6 and the quality of the film was assessed. For comparison, coating was effected with WD1 and WD2.

TABLE 6
Coating of glass with formulation F.5 according to the invention and
comparative experiments

| | Contact angle [°], | Contact angle [°], | |
|---|---|---|---|
| | Drying temperature: | Drying temperature: | |
| | 20° C. | 125° C. | Remarks |
| F.5 | 102.3 | 108.6 | Smudge-proof, |
| | | | more opaque |
| WD1 | 79.3 | 78.6 | Smudge-proof, |
| | | | transparent |
| WD2 | 81.7 | 81.5 | Smudge-proof, |
| | | | transparent |

1. A method for coating surfaces comprising coating a surface with a composition comprising:
(A) at least one ethylene copolymer wax selected from those ethylene copolymer waxes which comprise, incorporated in the form of polymerized comonomers,
(a) from 15 to 40% by weight of at least one ethylenically unsaturated carboxylic acid and
(b) from 60 to 85% by weight of ethylene,
and those ethylene copolymer waxes which comprise, incorporated in the form of polymerized units,
(a′) from 14.5 to 39.9% by weight of at least one ethylenically unsaturated carboxylic acid,
(b′) from 60 to 85.4% by weight of ethylene and
(c′) from 0.1 to 15% by weight of at least one ester of an ethylenically unsaturated carboxylic acid,
in each case in at least partly neutralized form, and
(B) at least one further wax which differs from ethylene copolymer wax (A) wherein the surface is selected from a cellulose-containing substrate, a glass substrate or a plastic substrate.

2. The method according to claim 1, wherein at least one ethylenically unsaturated carboxylic acid (a) or (a′) has the general formula I, 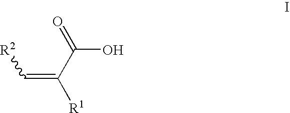
where the radicals are defined as follows:
R¹ is selected from hydrogen or straight-chain or branched C₁-C₁₀-alkyl,
R² is selected from hydrogen, COOH and straight-chain or branch C₁-C₁₀-alkyl.

3. The method according to claim 1, wherein at least one ester of an ethylenically unsaturated carboxylic acid (c′) has the general formula II 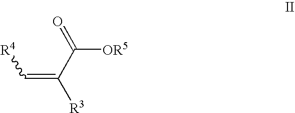
where the radicals are defined as follows:
R³ is selected from hydrogen or straight-chain or branched C₁-C₁₀-alkyl,
R⁴ is selected from hydrogen or straight-chain or branched C₁-C₁₀-alkyl,
R⁵ is selected from straight-chain or branched C₁-C₁₀-alkyl or C₃-C₁₂-cycloalkyl.

4. The method according to claim 1, wherein R¹ is methyl.

5. The method according to claim 1, wherein R² is hydrogen.

6. The method according to claim 1, wherein the ethylene copolymer wax or waxes (A) is or are at least partly neutralized with a basic alkali metal compound or at least one amine.

7. The method according to claim 1, wherein the ethylene copolymer wax or waxes (A) is or are at least partly neutralized with an amine, at least one amine being selected from ammonia, N-alkylethanolamines, alkanolamines and polyamines.

8. The method according to claim 1, wherein surfaces are selected from surfaces of metals, coated or uncoated, cellulose-containing substrates, textile, natural and synthetic sheets and adhesives.

9. The method according to claim 1, wherein at least one wax (B) is selected from paraffin waxes.

10. The method according to claim 1, wherein surfaces are provided with a film of ethylene copolymer wax (A) and further wax (B), which has a thickness in the range from 1 to 300 μm when wet.

11. The method according to claim 1, wherein at least one aqueous emulsion or dispersion comprising at least one ethylene copolymer wax (A), at least one further wax (B) which differs from ethylene copolymer wax (A) and, optionally, at least one surfactant (C) is applied to the surface to be coated.

12. The use of at least partly neutralized ethylene copolymer wax (A) by a method according to claim 1.

13. A coated surface obtainable by a method according to claim 1.

14. An article comprising at least one surface according to claim 13.

15. An aqueous formulation comprising at least one ethylene copolymer wax (A) selected from those ethylene copolymer waxes which comprise, incorporated in the form of polymerized comonomers,
(a) from 15 to 40% by weight of at least one ethylenically unsaturated carboxylic acid and
(b) from 60 to 85% by weight of ethylene,
and those ethylene copolymer waxes which comprise, incorporated in the form of polymerized units,
(a′) from 14.5 to 39.9% by weight of at least one ethylenically unsaturated carboxylic acid,
(b′) from 60 to 85.4% by weight of ethylene and
(c′) from 0.1 to 15% by weight of at least one ester of an ethylenically unsaturated carboxylic acid,
in each case in at least partly neutralized form,
and at least one further wax (B) which differs from ethylene copolymer wax (A), at least one solid in particulate form (D) and, if appropriate, at least one surfactant (C).

16. A process for the preparation of an aqueous formulation according to claim 15, wherein ethylene copolymer wax (A), at least one further wax (B) which differs from ethylene copolymer wax (A), at least one solid in particulate form (D), water and, if appropriate, at least one surfactant (C) are mixed at a temperature which is below the melting point of wax (B).

17. A process for the preparation of an aqueous formulation according to claim 15, wherein ethylene copolymer wax (A) is mixed with at least one further wax (B) which differs from ethylene copolymer wax (A) and with at least one solid in particulate form (D) in water at a temperature which is above the melting point of wax (B).

18. A process for the preparation of an aqueous formulation according to claim 15, wherein ethylene copolymer wax (A) in unneutralized form is mixed with at least one further wax (B) which differs from ethylene copolymer wax (A) and with at least one solid in particulate form (D) in water at a temperature which is above the melting point of wax (B) and of ethylene copolymer wax (A), and is at least partly neutralized with base simultaneously with the mixing or thereafter.
